(19) United States
(12) Patent Application Publication
(10) Pub. No.: US 2023/0001618 A1
(43) Pub. Date: Jan. 5, 2023

(54) CARBON-FIBER FUEL TANK

(71) Applicant: Connie Jackson, Harriman, TN (US)

(72) Inventor: Connie Jackson, Harriman, TN (US)

(21) Appl. No.: 17/364,776

(22) Filed: Jun. 30, 2021

(51) Int. Cl. B29C 48/05; D01F 6/18; D01F 9/22

(52) U.S. Cl. CPC B29C 48/05; D01F 6/18; D01F 9/22; B29L 2031/7172

(57) ABSTRACT

A vehicle includes a vehicle body and a vehicle propulsion system. The vehicle propulsion system includes a fuel tank having a nozzle and a tank body. The tank body is made, at least in part, from carbon fiber materials. A method of producing a carbon fiber component for the vehicle is also described.

### BACKGROUND

The present disclosure relates to vehicles, and particularly to a fuel tank for a vehicle. More particularly, the present disclosure relates to a fuel tank including carbon fiber and a method of forming a carbon fiber.

### SUMMARY

According to the present disclosure, a vehicle includes a vehicle body and a vehicle propulsion system. The vehicle body is configured to support one or more passengers for transportation in the vehicle. The vehicle propulsion system is configured to provide power for the vehicle to move the vehicle body and any passenger therein to transport the passenger(s) from one point to another.

In illustrative embodiments, the vehicle propulsion system includes a motor and a fuel tank. The fuel tank may be a hydrogen fuel tank and includes carbon fiber materials having a high-strength so that the hydrogen fuel tank can withstand a high internal pressure. Other parts or components of the vehicle may also be made from the carbon fiber material.

In illustrative embodiments, the hydrogen fuel tank includes a tank body and a release valve. The tank body defines the interior fuel-storage region and stores the hydrogen fuel. The release valve is coupled to the tank body and is configured to control release of the hydrogen fuel from the interior fuel-storage region. The tank body includes an inner tank liner and an outer tank wrapping. The inner tank liner is made from a polymeric material and lines an inner surface of the outer tank wrapper to at least partially define the interior fuel-storage region. The outer tank wrapper covers the inner tank liner and strengthens the tank body to withstand the high pressure imparted on the tank by the hydrogen fuel in the interior fuel-storage region.

In illustrative embodiments, the outer tank wrapping includes a plurality of reinforcement fibers suspended in a resin matrix. The plurality of reinforcement fibers extend through the outer tank wrapping of the tank body. The resin matrix binds the plurality of reinforcement fibers together.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a side elevation view of a vehicle including a vehicle body and a vehicle propulsion system, the vehicle propulsion system including a fuel tank shown through a cutout formed in the vehicle body and showing portions of the fuel tank cut away to show that the fuel tank includes carbon fiber;

FIG. 2 is an enlarged view of a portion of the fuel tank shown in FIG. 1 showing that the carbon fiber includes a plurality of reinforcement fibers suspended in a resin matrix to bind the plurality of reinforcement fibers together;

FIG. 3 is an enlarged view of a portion of the fuel tank shown in FIG. 2 showing that each of the reinforcement fibers has a dog-bone shaped cross section formed as a result of dry spinning the fibers during a carbon-fiber forming process as shown in FIGS. 4 and 5;

FIG. 4 is a flow chart showing a carbon-fiber forming process in accordance with the present disclosure; and

FIG. 5 is a diagrammatic flow chart showing the carbon-fiber forming process.

### DETAILED DESCRIPTION

A vehicle 10 in accordance with the present disclosure includes a vehicle body 12 and a vehicle propulsion system 14. The vehicle body 12 is configured to support one or more passengers for transportation in the vehicle 10. The vehicle propulsion system 14 is configured to provide mechanical power for the vehicle 10 to move the vehicle body 12 and any passenger therein to transport the passenger(s) from one point to another.

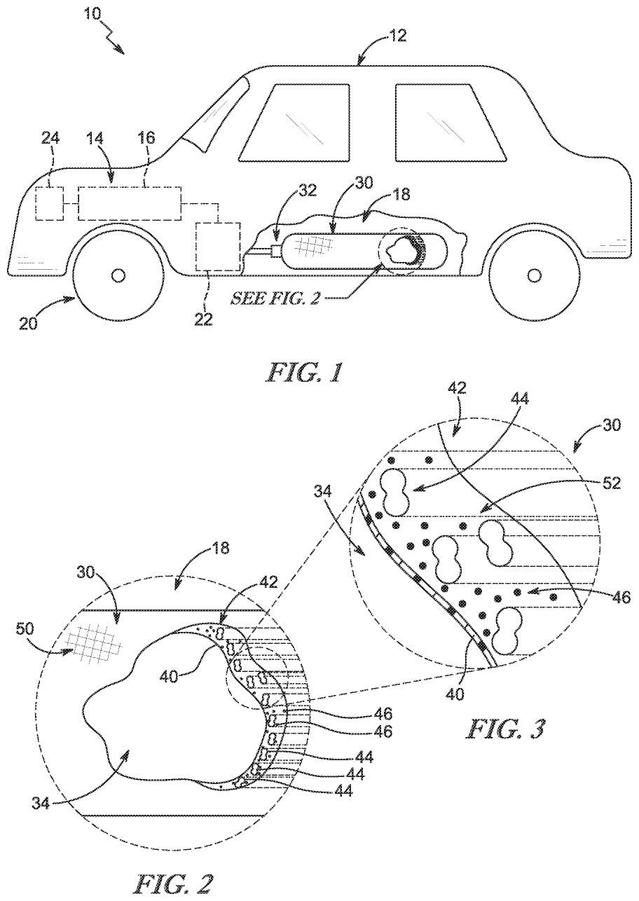

The vehicle propulsion system 14 includes, at least, a motor 16 and a fuel tank 18 as shown in FIG. 1. The motor 16 is configured to drive at least one wheel 20, included in the vehicle body 12, in rotation so that the vehicle body 12 moves across ground to transport occupants and items. The fuel tank 18 stores and releases a fuel that is used to provide energy for the motor 16 to drive the one or more wheels 20 in rotation.

In the illustrative embodiment, the vehicle propulsion system 14 is a hydrogen fuel system including an electric motor 16, a hydrogen fuel tank 18, a hydrogen fuel cell 22, and a battery 24. The hydrogen fuel tank defines an interior fuel-storage region 34 that stores hydrogen fuel for use by the hydrogen fuel cell 22. The hydrogen fuel cell 22 is configured to circulate the hydrogen fuel there through to generate electrical power. The electrical power is used by the electric motor 16 to drive rotation of the at least one wheel 20. The electrical power may be transferred to the battery 24 for storage and use by the electric motor 16.

The hydrogen fuel tank 18 is made from materials having a high-strength so that the hydrogen fuel tank 18 can withstand an internal pressure of at least 350 bar. The hydrogen fuel tank 18 includes a tank body 30 and a release valve 32. The tank body defines the interior fuel-storage region 34 and stores the hydrogen fuel. The release valve 32 is coupled to the tank body 30 and is configured to control release of the hydrogen fuel from the interior fuel-storage region 34 to the hydrogen fuel cell 22. The release valve 32 may also control return of circulated hydrogen fuel to the interior fuel-storage region 34 after being circulated through the hydrogen fuel cell 22.

The tank body 30 includes an inner tank liner 40 and an outer tank wrapping 42 as shown in FIGS. 2 and 3. The inner tank liner 40 is made from a polymeric material and lines an inner surface of the outer tank wrapper to at least partially define the interior fuel-storage region 34. The outer tank wrapper 42 covers the inner tank liner 40 and strengthens the tank body 30 to withstand the high pressure imparted on the tank 18 by the hydrogen fuel in the interior fuel-storage region 34.

The outer tank wrapping 42 is made from a carbon fiber material that includes a plurality of reinforcement fibers 44 suspended in a resin matrix 46 as shown in FIGS. 2 and 3. The plurality of reinforcement fibers (also called filaments) 44 are strands of carbonized precursor material that extend through the resin matrix. The plurality of reinforcement fibers 44 may be generally parallel with one another or arranged to extend in different directions compared to one another through the resin matrix 46. The resin matrix 46 binds the plurality of reinforcement fibers 44 together. Together, the plurality of reinforcement fibers 44 and the resin matrix 46 form the outer tank wrapping 42 of the tank body 30.

The outer wrapping 42 may be formed as a single, monolithic component made from the plurality of reinforcement fibers 44 and the resin matrix 46 or may be formed from a plurality tows or ribbons 50 as shown in FIG. 2. The plurality of tows or ribbons 50 may be woven together to form a bi-directional weave and then bound together by infiltration of the resin matrix 46 and/or an adhesive. Additionally, the outer tank wrapping 42 may include a plurality of layers that are bound together by the resin matrix 46 to provide a plurality of radially-stacked reinforcement fibers 52 relative to a central, longitudinal axis of the fuel tank 12 as shown in FIG. 3.

Each of the reinforcement fibers 44 is made from a textile acrylic fiber precursor material including polyacrylonitrile (PAN). Each of the reinforcement fibers 44 may include a plasticizer such as methylacrylate or vinyl acetate. In one embodiment, each reinforcement fiber 44 includes 90 mole % PAN and 10 mole % methylacrylate. Each reinforcement fiber 44 may include between 90-96 mole % PAN and between 4-10 mole % plasticizer. The resin matrix 46 may include a thermoset resin such as an epoxy resin, polyester resin, or a vinyl ester resin.

Each of the reinforcement fibers 44 has a dog-bone cross-sectional shape as shown in FIG. 3. The dog-bone cross-sectional shape has two opposing, rounded ends having a first width and a central portion linking the two ends and having a second width less than the first width. In other embodiments, the reinforcement fibers 44 may have other suitable cross-sectional shapes such as round, oblong, etc.

In some embodiments, the dog-bone cross sectional shape has a roundness value of less than or equal to 0.7. Roundness may be calculated using the following roundness formula: Roundness=4πS/L², where S=cross sectional area and L=circumferential length.

In one example, the roundness of each filament is calculated by approximating the cross section to a rectangle. Using a rectangle that is 4 microns wide multiplied by 10 microns long (about one filament 44 cross-sectional size) the roundness=0.64. However, the dog bone shape is not exactly a rectangle so the cross sectional area would be less than the rectangle and the circumference would be longer than the rectangle. Therefore, the exact roundness of a dog bone that would fit inside a 4×10 rectangle would be less than 0.64, in one example.

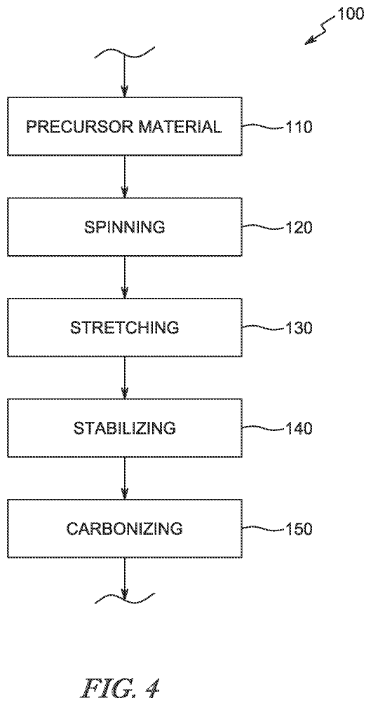

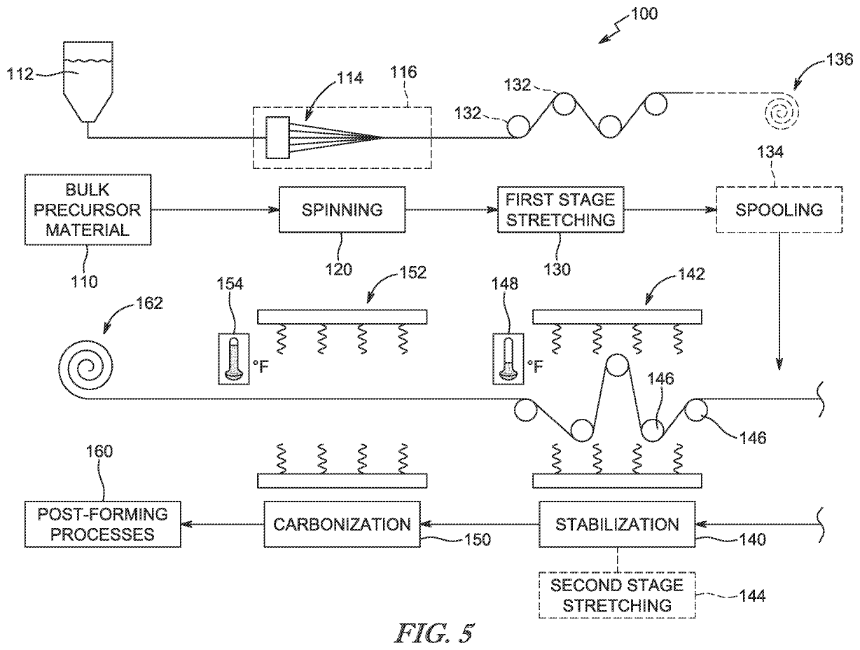

Each reinforcement fiber 44 is formed during a carbon-fiber forming process 100 as shown in FIGS. 4 and 5. The carbon-fiber forming process 100 includes a step 110 of providing precursor material 112 and extruding the precursor material to form filament strands 114. The precursor material 112 may include the PAN and plasticizer described above.

The filament strands 114 are then dry spun in a dry spinning operation 116 at a step 120. Dry-spinning the filament strands 114 causes the filament strands 114 to have a dog-bone shaped cross-section. In the illustrative embodiment, the filament strands 114 have no initiator added to them following step 120 of dry-spinning. The filaments 114 are approximately 3.4 deniers per filament after the step 120 of spinning.

The process 100 continues with a first stage stretching step 130. The plurality of filaments 114 may be stretched by a plurality of rollers 132 during the step 130 of stretching. In the illustrative embodiment, the filaments 114 are stretched about 4× to 5× their length prior to the step 120 of spinning. In some embodiments, the step 130 of stretching occurs during the step 120 of spinning. The process 100 continues with an optional step 134 of spooling the stretched filaments into a spool or bobbin 136 for storage prior to further processing.

The process 100 further includes a step 140 of stabilizing the filaments 114. During the step of stabilizing, the filaments 114 pass through heaters 142 and are heated at a first temperature 148. The first temperature 148 may be any value within a range of about 200 degrees Celsius to about 300 degrees Celsius. The filaments 114 also undergo second stage stretching 144 during and/or after the step 140 of stabilizing. This is possible because no initiator is present on the filaments 114. During the second stage stretching step 144 the filaments 114 may passed around rollers 146.

The process 100 further include a step 150 of carbonizing the filaments 114. During the step 150 of carbonizing, the filaments pass through one or more heaters 152 and are heated to a second temperature 154 higher than the first temperature. The second temperature 154 may be any value within a range of about 1200 degrees Celsius to about 2000 degrees Celsius. Following the step 150 of carbonizing the plurality of reinforcement fibers 44 are formed and are ready to be mixed with resin matrix 46 to form a carbon fiber.

The process 100 may further include one or more post-forming processes at step 160 such as graphitization, spooling 162, surface treating, weaving, molding into a particular carbon-fiber component, or any other suitable post-forming process. Resin matrix 46 may also be added to the reinforcement fibers 44 during the post-forming step 160.

In some embodiments, the process may include three manufacturing operations or steps. The first step is the acrylic fiber spinning operation. Carbon fiber precursor or specialty acrylic fiber (SAF) spinning is different from textile acrylic fiber (TAF) spinning. Dog bone (DB) shaped polyacrylonitrile (PAN) filaments may be dry spun. Dry spinning may be a more efficient, cost effective and environmentally friendly spinning operation compared to wet spinning that produces round fibers. Some DB-TAF is wet spun and all carbon fiber precursor is wet spun, usually with an air gap of no more than 6 mm. In some embodiments using wet spinning PAN technology or methods, the filament cross section shape for commercial carbon fiber is round. The inventors unexpectedly found that they were able to produce high performance carbon fiber using DB-TAF as the precursor rather than SAF using process 100.

In some embodiments, the second operation is the stabilization of the precursor, also commonly called oxidation. The precursor fiber mass load is maintained at an optimal oxygen diffusion rate and production efficiency level. The third operation is carbonization. In current carbon fiber line designs, the stabilization operation occurs sequentially prior to the carbonization operation.

In some embodiments, the cost metrics of SAF compared to DB-TAF may be unfavorable due to the comparatively low volume production in SAF spinning operations. In some embodiments, the spinning of DB-TAF has much higher productivity through advanced manufacturing technology and efficiency advantages over SAF. The present disclosure produces high performance carbon fiber from DB-TAF precursor using the proper post spinning process and conversion steps including one or more post-spinning stretching steps and one or more pre-heating steps before, during, or after the stretching steps.

In some embodiments, the shape of the cross section is dog bone that is approximately 2.5× longer than it is wide. The deci-tex (dtex) (i.e. grams per 10,000 meters of yarn) of each carbon fiber filament is approximately 1.0 but can be more or less depending on the starting dtex of the precursor. The dog bone shape allows a higher, more efficient starting dtex or denier filament than round filaments. In one example, the dog bone shaped filaments have up to 3.6 dtex due to the improved oxygen diffusion through the narrow dimension compared to round filaments that have a larger radius and less oxygen diffusion. For example, a round carbon fiber precursor filament may be 18 microns. In this example, the oxygen must penetrate or diffuse to the center of the circle with a radius of 9 microns. In the case of the dog-bone shaped filament of equivalent cross sectional area, the oxygen must only penetrate through the narrow dimension of approximately 4 microns making diffusion faster and more uniform.

In some embodiments, the polyacrylonitrile precursor filaments may include between 90-96 mole % acrylonitrile with a comonomer of methylacrylate as a plasticizer. In some embodiments, there is no need for an initiator. The filaments are approximately 3.4 deniers per filament after spinning. The precursor fiber may be manufactured using a preferred textile acrylic fiber dry-spinning process that produces dog-bone shaped cross-section filaments. The precursor fiber mass load is maintained at an optimal oxygen diffusion rate and production efficiency level. The stabilization fiber loading is maintained at less than 140,000 deniers per inch width throughout the stabilization process by processing the fiber in multiple levels at low temperatures through the initial zones of thermal processing at a temperature that is lower than both the stabilization step and the carbonization step. This level of loading at the prescribed temperatures without an initiator present avoids fiber fusing as well as creating a skin beginning at the surface of the filaments that slows diffusion of oxygen into the filaments in the earliest stage of stabilization. This thorough diffusion provides higher performance carbon fiber.

In some embodiments, there may be some differences between how SAF is prepared in the spinning operation versus how DB-TAF is prepared. The DB-TAF PAN fibers may contain between 1% and 10% comonomer. DB-TAF may have vinyl acetate or methyl acrylate as its co-monomer. The source of PAN may be petroleum based, rapeseed oil based, or other biomass based.

In some embodiments, the degree of orientation of carbon in the PAN molecular chain is difference between SAF and DB-TAF filaments due to the difference processes used to form each. SAF filaments may have a high stretch ratio provided by the SAF wet-spinning process. In one example, SAF filaments are stretched over 14× in the wet-spinning operation. By contrast, the DB-TAF filaments are stretched only about 4 times to 5 times in the dry-spinning operation. Thus, a post spinning stretch step may be included in the process. In some embodiments, the filaments are re-stretched up to an additional 4 times in the post-spinning stretching step. In some embodiments, the filaments are stretched an additional amount within a range of about 1.1 times to about 3 times during the post-spinning stretching step. The post-spinning stretching step is performed at a temperature within a range of about 100 degrees Celsius to about 200 degrees Celsius. The post-spinning stretching step may also be used to properly orient the molecular chain for optimal mechanical performance.

In some embodiments, SAF filaments are produced using an initiator added to the PAN polymer. The initiator may be added to SAF filaments to reduce the onset temperature of cyclization and crosslinking in order to oxidize the fiber faster in the conventional conversion process. The onset temperature reduction caused by the initiator in SAF means that the SAF fiber polymer will start to crosslink at about 210 degrees Celsius before it reaches a high enough temperature to allow the fiber to become easily stretchable. The crosslinking begins on the surface of the filament where a skin is created around the filament by the initiator. This skin inhibits the rate of oxygen diffusion into the filament, slowing the oxidation process. In such a process, thermal management may need to be tightly controlled to block developing such a thin outer skin that the oxygen can't diffuse through it. Stretching the fiber in oxidation after crosslinking begins may damage the crosslinked bonds, cause fiber breakage, and reduce the mechanical performance of the resultant carbon fiber. SAF used in conventional carbon fiber conversion cannot be significantly stretched following the spinning step in stabilization, for example. In the illustrative embodiment, DB-TAF filaments are used and no initiator is applied so that post-spinning stretching is possible without damaging the filaments.

In some embodiments, two objectives in stabilization may be oxygen diffusion and cyclization. As mentioned earlier, with SAF, oxygen diffusion rate is slowed by the skin that develops on the surface of the filament due to early crosslinking. This is mitigated by the increased rate of cyclization caused by the initiator to help increase the line speed. Crosslinking may take place with cyclization and is optimally performed in later stages of stabilization after significant oxygen diffusion has taken place. It requires close thermal and fiber management of the precursor in order to diffuse the fiber with oxygen thoroughly before significant crosslinking takes place.

1. A method of forming a carbon fiber, the method comprising the steps of:
providing a textile acrylic fiber precursor material;
dry-spinning the precursor material to form a plurality of filaments from the precursor material, each filament having a dog-bone shaped cross section;
stretching each of the plurality of filaments during the step of dry spinning the precursor material;
stabilizing each of the plurality of filaments;
re-stretching each of the plurality of filaments after the step of spinning and before, during, or after the step of stabilizing; and
carbonizing each of the plurality of filaments.

2. The method of claim 1, wherein the step of stretching includes stretching the plurality of filaments within a range of about 4 times to about 25 times the length of each filament strand prior to the step of stretching.

3. The method of claim 2, wherein the step of re-stretching includes stretching the plurality of filaments an additional amount within a range of about 1.1 times to about 3 times.

4. The method of claim 3, wherein no initiator is added to the plurality of filaments.

5. The method of claim 1, wherein the precursor material includes at least 90% mole polyacrylonitrile and less than or equal to 10% co-monomer.

6. The method of claim 5, further comprising a step of molding the plurality of filaments into a cylindrical hydrogen fuel tank.

7. The method of claim 6, further comprising a step of binding the plurality of filaments together with a resin matrix.

8. A fuel tank comprising
a carbon fiber wrapping and
an internal polymeric liner disposed on an inside surface of the carbon fiber wrapping and defining an internal fuel-storage space,
wherein the carbon fiber wrapping includes a resin matrix and a plurality of carbon fibers that include dry-spun, textile acrylic filaments having a dog-bone shaped cross section.

9. The fuel tank of claim 8, wherein the plurality of carbon fibers are bi-directionally woven to form the carbon fiber wrapping.

10. The fuel tank of claim 9, wherein the carbon fiber wrapping includes a plurality of radially stacked layers.

11. The fuel tank of claim 9, wherein the carbon fiber wrapping is a monolithic component.

12. The fuel tank of claim 8, wherein each of the dry-spun, textile acrylic filaments includes at least 90 mole % polyacrylonitrile and less than or equal to 10 mole % methylacrylate.

13. A vehicle propulsion system comprising
an electric motor configured to drive rotation of at least one wheel,
a hydrogen fuel cell configured to produce electrical energy for the electric motor, and
a hydrogen fuel tank including a tank body defining an interior fuel-storage space and a release valve coupled to the tank body and configured to release hydrogen fuel from the interior fuel-storage space to the hydrogen fuel cell during operation of the vehicle propulsion system,
wherein the tank body includes a carbon fiber wrapping and an internal polymeric liner disposed on an inside surface of the carbon fiber wrapping and defining the internal fuel-storage space, the carbon fiber wrapping including a plurality of carbon fibers including dry-spun, textile acrylic filaments having a dog-bone shaped cross section and a resin matrix binding the plurality of dry-spun, textile acrylic filaments.

14. The vehicle propulsion system of claim 13, wherein the plurality of carbon fibers are bi-directionally woven.

15. The vehicle propulsion system of claim 14, wherein the carbon fiber wrapping includes a plurality of radially stacked layers.

16. The vehicle propulsion system of claim 14, wherein the carbon fiber wrapping is a monolithic component.

17. The vehicle propulsion system of claim 13, wherein each of the dry-spun, textile acrylic filaments includes at least 90 mole % polyacrylonitrile and less than or equal to 10 mole % methylacrylate.

18. The vehicle propulsion system of claim 13, wherein each of the filaments has a roundness of less than 0.7.
